(19) United States
(12) Patent Application Publication
(10) Pub. No.: US 2026/0179442 A1
(43) Pub. Date: Jun. 25, 2026

(54) EGM AND TABLE GAME ENHANCEMENT USING GESTURE INTERACTIONS WITH MULTIPLAYER LINKED DEPTH SENSING FOR 3D CO-PLAY

(71) Applicant: IGT, Las Vegas, NV (US)

(72) Inventors: David FROY, Lakeville-Westmorland (CA); Gaurav JARIWALA, Halifax (CA); Harshit AGARWAL, Halifax (CA); Sven AURICH, Schwanberg (AT); Michael RUSS, Graz (AT); Stefan KEILWERT, St. Josef 8503 (AT)

(73) Assignee: IGT, Las Vegas, NV (US)

(21) Appl. No.: 18/988,410

(22) Filed: Dec. 19, 2024

(51) Int. Cl. G07F 17/32; G06T 7/10; G06V 40/20

(52) U.S. Cl. CPC G07F 17/3241; G06T 7/10; G06V 40/28; G07F 17/3225; G06T 2207/10024; G06T 2207/10048; G06T 2207/20044

(57) ABSTRACT

A system includes a processor circuit and a memory coupled to the processor circuit. The memory includes machine-readable instructions that, when executed by the processor circuit, cause the processor circuit to perform operations that include transmitting, to equipment of another player, data corresponding to a game on an electronic gaming machine (EGM). Operations include providing a communication link between the player of the EGM and another player and generating a skeletal model of the player from multiple images. The skeletal model is movable to match movement of the player. Operations include receiving, via an artificial intelligence (AI), AI data in a real time video stream that is captured through one of multiple depth sensing cameras. Operations include determining an outcome based on a result of the mechanical game feature and monitoring a participating mechanical game feature using the plurality of depth sensing cameras.

### BACKGROUND

Embodiments described herein relate to network-connected wagering games, and in particular to providing live dealers to remote gaming tables in a casino environment, and related devices, systems, and methods. Table games in casinos may provide wagering opportunities for players at the tables for primary wagering games as well as side bets or other secondary games. Live dealers for physical table games typically rotate among different tables in a single casino on a set schedule, making it difficult for players to play wagering games with specific dealers at specific times. There is a need for a unique technical solution to the technical problem of matching players with specific live dealers to enhance player enjoyment.

### BRIEF SUMMARY

According to some embodiments, a system includes a processor circuit and a memory coupled to the processor circuit. The memory includes machine-readable instructions that, when executed by the processor circuit, cause the processor circuit to operations herein. Some embodiments include a system that includes an electronic gaming machine (EGM) that includes multiple depth sensing cameras that generate multiple images corresponding to a player that are used to generate a point cloud that corresponds to a model of the player. Multiple audio transducers may be provided in a transducer array to perform beam forming using positional information of the player. The audio content may be adjusted and delivered to the player.

In some embodiments, a three-dimensional (3D) display device including multiple rendered video frames that are adjusted in real time may adjust a separation of each of multiple rendered video screens to generate a 3D image.

Some embodiments include a processor circuit and a memory coupled to the processor circuit. The memory may include machine-readable instructions that, when executed by the processor circuit, cause the processor circuit to perform operations including transmitting, to equipment of another player, data corresponding to a game on the EGM. Operations include providing a communication link between the player of the EGM and the other player.

A system may include a processor circuit and a memory coupled to the processor circuit. The memory includes machine-readable instructions that, when executed by the processor circuit, cause the processor circuit to perform operations including transmitting, to equipment of another player, data corresponding to a game on an electronic gaming machine (EGM) and providing a communication link between the player of the EGM and another player. Operations may include generating a skeletal model of the player from multiple images. The skeletal model is movable to match movement of the player. Some embodiments include receiving, via an artificial intelligence (AI), AI data in a real time video stream that is captured through one of multiple depth sensing cameras.

Some embodiments include training to distinguish multiple player hands in a camera view. Embodiments include compressing user depth information and color reproduction of the model of the player. Some embodiments include transmitting compressed user depth information and color reproduction data to another player EGM. A mechanical game feature may be initiated and an outcome may be determined based on a result of the mechanical game feature. Operations include monitoring a participating mechanical game feature using the depth sensing cameras.

According to some embodiments, a method includes transmitting, to equipment of a first player, data corresponding to a game on a EGM and providing a communication link between the first player and a second player via respective EGMs. Embodiments include generating a skeletal model of the first player from multiple images. In some embodiments, the skeletal model is movable to match movement of the first player. Operations include receiving, via an artificial intelligence (AI), AI data in a real time video stream that is captured through one of the depth sensing cameras. Embodiments include training the AI to distinguish multiple player hands in a camera view.

Some embodiments include compressing user depth information and color reproduction of the model associated with the first player and transmitting compressed user depth information and color reproduction data to the second player EGM.

Some embodiments include initiating a mechanical game feature, determining an outcome based on a result of the mechanical game feature, and monitoring a participating mechanical game feature using the multiple depth sensing cameras.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic block diagram illustrating various operations for a blockchain token transaction according to some embodiments

FIG. 4 is a schematic block diagram illustrating a system according to some embodiments.

FIG. 5 is a flowchart illustrating operations of systems/methods for facilitating embodiments described herein.

FIG. 6 is a flowchart illustrating operations of systems/methods for facilitating embodiments described herein.

FIG. 7 is a flowchart illustrating operations of systems/methods for facilitating embodiments described herein.

### DETAILED DESCRIPTION

Embodiments herein may include allowing a player to play a traditional table game, IE Poker, Keno, Bingo, Blackjack with other players and/or to join a table and allow for three-dimensional (3D) immersion and interaction with other players and/or tables.

Some embodiments may include the integration of gesture tracking into gameplay using depth-sensing cameras. Some embodiments provide that, for multiplayer purposes, a dynamic and interactive dimension may be included in bonus rounds, such as two people breaking a piñata in a 3D space. Such embodiments include technology that may leverage precise tracking of the X, Y, and Z coordinates of both players' fingers and/or a stylus, enabling players to interact with and manipulate objects within a virtual environment in real-time. Some embodiments may enhance the immersive experience of 3D digital multiplayer gaming and/or may open up new avenues for innovative gameplay mechanics, upbeat game environment and/or co-op modes.

In this manner, a player may talk naturally, gesture and/or make eye contact, among others.

In a casino setting, some table-based games may be more enjoyable to be played with multiple players. Additionally, some games may require more than one player. Players in each venue may not meet the requisite number to play a given game. In some embodiments, users may be allowed to have a novel user experience, which may be advantageous for players who cannot travel to casino locations. In some embodiments, based on the technology of telepresence and/or other user interactions, the user may be able to interact in a shared gaming experience.

Embodiments herein may include one or more cameras with depth sensors, infrared sensors, a 3D display to show the depth of person, spatial audio technology, and/or a deck shuffler connected to remote dealer.

In some embodiments, an immersive gaming atmosphere may be provided for players that may not be able to travel to casino locations. In some embodiments, operating hours may be extended to cater to international and/or players from different time zones or operating on different calendars. Some embodiments provide that revenue may be generated through a subscription-based model for gesture control gameplay.

An EGM may be installed with a series of two or more depth sensing cameras. In some embodiments, the depth sensing cameras may include IR sensing and/or color sensing. In some embodiments data from the depth sensing cameras may be used to generate a point cloud from the combination of multiple images. The point cloud may be used to generate a model of the user. In some embodiments, the model may provide tracking of hands and/or fingers of the user with a similar generated point cloud. In some embodiments, the point cloud may be used to build a 3D skeletal model of the user and may be able to move the skeletal model in real time with the players movement.

For audio, a system may use a series of multiple audio transducers in an array and using beam forming and the tracking positional information of the user to adjust the beam of the audio for the user.

Some embodiments provide that the main screen of the EGM may be a 3D display which uses the depth sensing cameras to track the user position and that adjusts the two rendered frames in real time to adjust the separation of the two images. The images may be generated by creating a 3D frustum based upon the user's head position and angle in relation to the screen. This information may be used by a 3D game engine which then projects two virtual cameras into the 3D scene which then is rendered to stereoscopic rendered images. The stereoscopic rendered images may then be transmitted to the screen by the video card. This may be formatted based upon the required format of the screen. Some embodiments provide that two separate images may be stitched into a single image, two images may be combined with one another, and a 2D color image and a gray scale depth buffer image may be combined.

The user's depth information and/or color reproduction of the model of the player may be compressed and transmitted to other EGMs connected either directly and/or by a server over a network. In some embodiments the transmission may be over the internet and/or intra-net, among others.

When a player first sits down at an EGM, they may be prompted to login to the service. In some embodiments, the player may login via a connected mobile device, a player card, and/or facial recognition, among others. Once logged in, the player may have a list of friends that may appear on the main screen and/or digital player panel (e.g., a button panel with a screen and/or top screen.) The user may then be able to select a friend and choose to play along with them. In some embodiments, the players may view each other and speak with each other through the use of a microphone and/or array of microphones that may be built into the EGM. In some embodiments, a microphone of the user's mobile device may be used to transmit their friend's EGM.

Users may also join with a group of players instead of just one person. Some embodiments provide that the player may send an invite to a friend to join a group game.

When players are playing with friends, they may cause their game to be transmitted to their friends via video streaming, and/or by sending game outcome information to their friends' machines. These outcomes may be used to re-generate the game state of the player at the same time and allow both to view the outcome of the first player's game.

Both players may see their game as well as the game of their friend at the same time. The players may see a 3D version of the actual friend upon the screen with various layouts. The user may choose the layout they wish to have from a series of options.

Another option according to some embodiments herein includes providing a mechanical game feature, such as roulette wheel, which may be viewed by two or more depth sensing cameras to be connected to the gaming experience. The video and/or depth information may be transmitted to the other EGMs that are using the mechanical game feature. The mechanical game feature may be controlled remotely by one of the EGMs, by a server and/or may be controlled by a dealer that would be controlling the mechanical game feature and would also have a depth camera and screen setup so they may monitor the players who are participating in the game feature.

Some embodiments provide that groups of players who are playing along on a mixed mechanical game feature may be able to place wagers on their EGMs. Some embodiments provide that once all the wagers are placed, the mechanical game feature may be started and the outcome result may be calculated based on the result of the mechanical game feature.

Some embodiments provide that one player may be able to use a gesture to trigger the action on the mechanical game feature that may be controlled by a server that may receive the gesture action and trigger an event on the mechanical game feature. In such embodiments, the trigger may include initiating the spinning of a wheel, dropping a ball to be played with the roulette wheel among other such actions.

In some embodiments, the depth sensing may be used to track the location of the ball used for games like roulette as well as dice for games like craps, etc. Some embodiments may provide that the wheel position may be tracked by other sensors built into the wheel such as using encoder wheel and light sensors to track or provide other such tracking technologies. Such information may be collected by the local controller and transmitted to each of the players who is participating in the game.

Some embodiments provide that AI inputs may be real time video stream captured through the camera recording hand movements of players.

In some embodiments, multiple hands in a camera's field of view may be distinguished from one another using the AI. In this manner, the system may avoid confusing between the right hand of one player and the right hand of another player. In this manner, an incorrect input may be avoided.

Some embodiments provide the ability to recognize gestures that are intended as input to the gameplay versus hand movements that a player naturally makes, such as, for example, sipping from a beverage and/or checking time on their watch.

In some embodiment, CNN models may be suitable architectures as they may work with image and/or spatial-based data. In some embodiments, a model can be maintained based on one or more feedback loops from players and/or customers, among others.

Some embodiments provide that the system may receive output in form of each hand that camera detects having tags associated with them to recognize specific players and to indicate whether the hand movement was a game input, or merely a player moving around. Some embodiments provide that an example includes a Boolean type output of 1 if hand gesture is an input or 0 if the movement is generic and thus is not a system input.

Some embodiments provide that the EGM cabinet may include a display of the dealer and a deck shuffler. The deck shuffler may synchronize with the video of the dealer and may serve the card to the player. In some embodiments, a video of the dealer can be AI based and/or pre-recorded. Some embodiments may include support for gestures and/or for other non-touch interactions. Embodiments may include gestures controlling the speed of a motor controlling physical wheels, among others. In some embodiments, physical controllers may be manipulated by players and transmitted to a dealer and/or another player setup.

Some embodiments provide gestures to control a deck shuffler. Some embodiments provide that the card may come out of machine matching the speed of the dealer's hand and/or the direction of the hand movement. Similar to the deck shuffler, a tile and/or domino-based controller devices can be included. In some embodiments, gesture control on dice-based games may be provided in which dice may be propelled via a small pressure cannon on the table and the speed, angle and force of launch would depend on player's hand movement.

In addition to gesture tracking, embodiments herein may provide personalized hand-tracking, per player. In some embodiments two players may be playing from two different locations in the same virtual environment. In such embodiments, each player's hand may be tracked through the sensor of each gaming device at different locations. Some embodiments provide that two players playing from the same gaming device may use one or multiple local sensors to detect both players' hands individually and thus use personalized hand tracking per player, to differentiate the two player's hands. In some embodiments, AI model training may be used to correctly recognize each player's personal hands, accurately. Some embodiments provide that the model may recognize bracelets, rings, and/or other accessories to more accurately differentiate their hands.

In some embodiments, a hand of the player may be scanned and/or tracked to create a virtual hand in the 3D-screen. Some embodiments provide that poker cards or other game components may be added to this virtual hand. In some embodiments, the player may use the second hand to select any card in their hand. In some embodiments, e-paper devices may be used as cards. In some embodiments, the e-paper cards may get their value from the system. Some embodiments provide that a deck of cards with five cards can be simulated.

Some embodiments may use, in part, a 3D depth screen, that may display 3D rooms and players. The rooms and players may be presented at high levels of realism. Some embodiments provide that two remotely located people may feel the interaction of sitting physically next to another. Through the 3D depth sensing based interaction, embodiments may be provided in which person A interacts with person B's 3D room and vice versa.

In some embodiments, collaborative table game interactions may include 3D hidden information. In this example, Player A may be missing information to complete their task, which may be choosing one out of 4 card colors for a side-game interaction. Player A may either make a random guess or find a hint to their task in player B's virtual 3D room. For example, the hint may be placed behind player B's head. To have player A achieve their task, player B must move their head to the side, so that player A can see the hidden hint floating in 3D space in the stream. Such embodiments may be used for any collaborative interaction between two or more players in a side game, such as a quest action, among others.

In some embodiments, collaborative interactions may include 3D blank objects. For example, in the context of e-paper devices in the form of cards, there might be multiple physical blank cards at player A's location with an optical code. By having player A place the cards into the 3D camera, the camera may track the optical code and/or augment content on the card that may only be visible to player B. Player B may then be able to communicate more detailed information to player A, such as finding which card is the correct card one to proceed.

In some embodiments, collaborative touch interactions may provide that in order to trigger an in-game action such as to initiate the next player's turn, or hand a virtual object from player A to player B), both players may need to “grab” the other's hand, by placing their hand at the exact same position as the other player in their location. Then, in response to touching the screen's surface right where the other player's hand is, the action may be triggered.

Embodiments herein may include a virtual roulette game and/or any other game, such as horse racing, keno, and/or spin a wheel, among others. Some embodiments provide that two or more players are looking into their 3D screen and that each player looks at the same roulette wheel (3D scene) but from their individual perspective in the virtual environment. Each player may see each other participating player sitting around the wheel/table that may be augmented with 3D content, such as a sorcerer's hat, sunglasses, and/or wig, among others.

In some embodiments, whenever a player interacts with the 3D-scene of the game, such as to place jetons, a virtual 3D hand of the player's hand is created in real-time and rendered into the 3D game scene to be visible to each other player from their individual perspective.

In some embodiments, players may use physical input devices such as, mouse, keyboard, and/or joystick among others to control their virtual hand to interact with the game. In some embodiments, multiple “hands” can interact with the game at the same time. Some embodiments provide that each 3D hand may be customized in terms of color, gloves, and/or fabric to differentiate one player from the other(s).

In some embodiments, a system that drives the game may be able to enable and/or disable game interactions based on the state of the game. Some embodiments may render virtual hands all of the time but enable/disable interactions with game elements. In such embodiments, the virtual hand may still be visible. In some embodiments, the system driving the game may allow restricted game interaction depending on game state. For example, placing jetons may be performed without turning the wheel including time and location restrictions.

Operations of games herein may include filling out a lotto/keno ticket together, taking turns spinning a wheel, placing your virtual horse onto the race-track and/or placing bets on the outcome, among others.

Some embodiments provide a more immersive bonus round experience as the player can interact with their gesture instead of pressing a button and/or pulling a handle.

Some embodiments provide that a player can have the option of co-op game play where another player can join their bonus round for a fixed fee to share the pot and/or to fight for the pot in the bonus round. If co-op mode is triggered, player may play for a bigger reward compared to solo bonus round.

Some embodiments provide that side betting can be enabled in co-op mode for other players to view the gameplay and/or to place live bets. In some embodiments, a bonus round may include breaking a piñata in 3D space in which a player's precision in X, Y and Z coordinates may need to be precise to win.

Some embodiments include selecting a treasure box and/or gift box to shake and break to win a prize using gesture.

Some embodiments provide multiple rows of cards moving in different directions and speed and that the player must select a card within a given area to align the line of cards to get perfect bonus.

In some embodiments, a player may need to buy a subscription to use gestures for controlling the game.

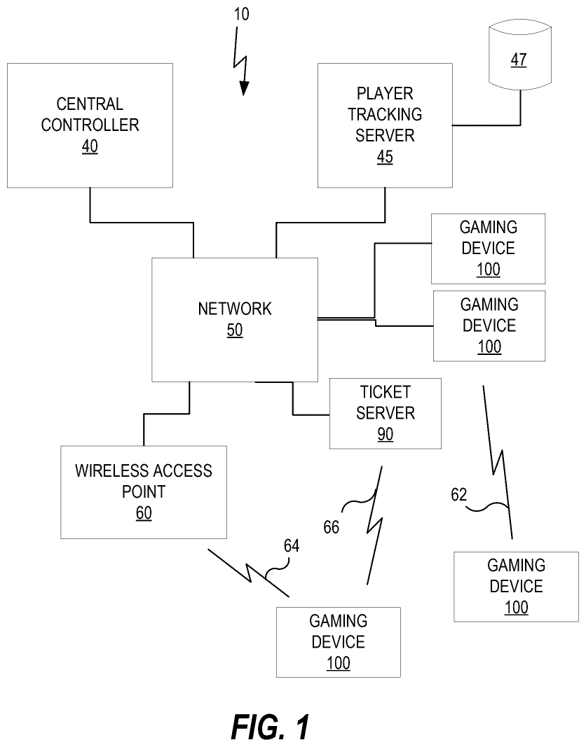

Embodiments described herein relate to network-connected wagering games, and in particular to providing live dealers to remote gaming tables in a casino environment, and related devices, systems, and methods. Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

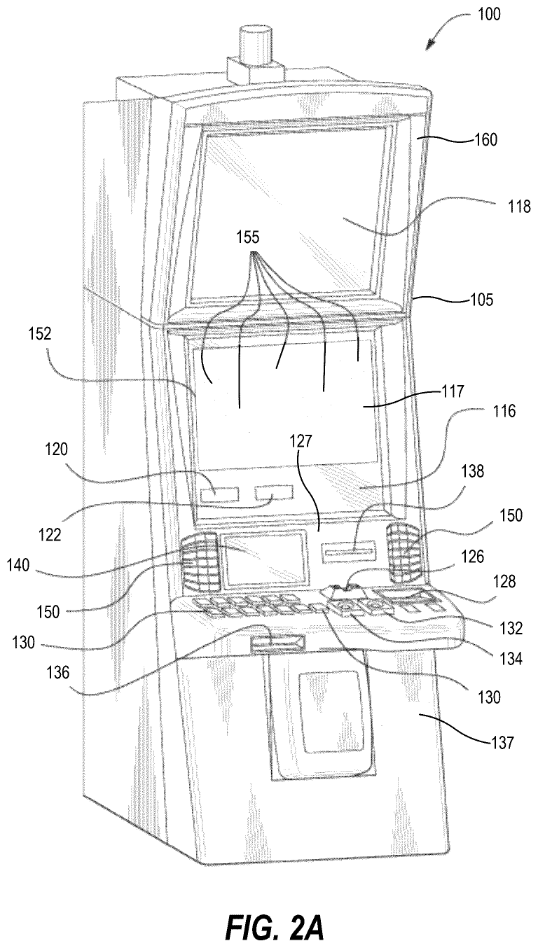

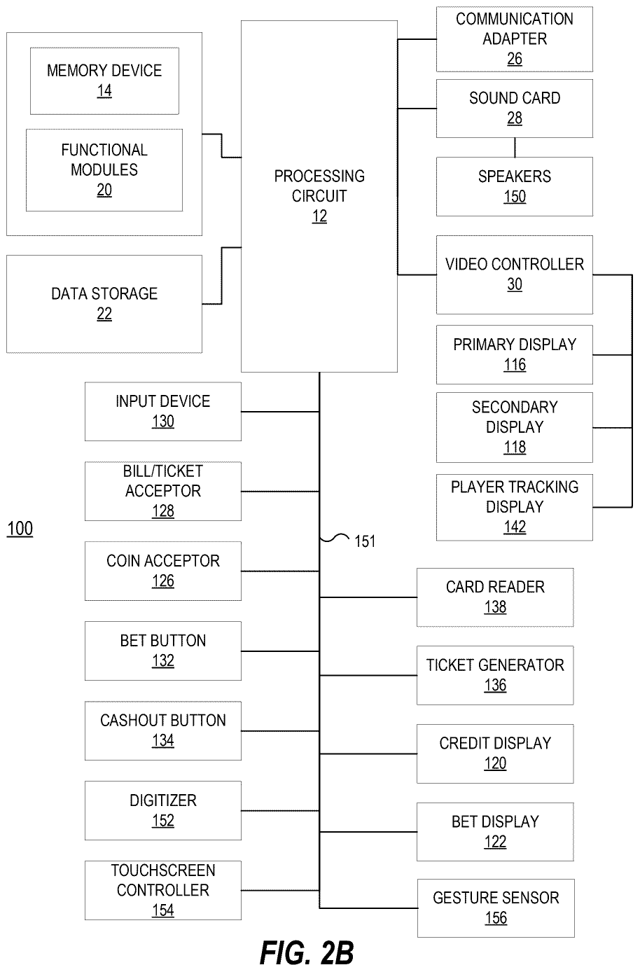

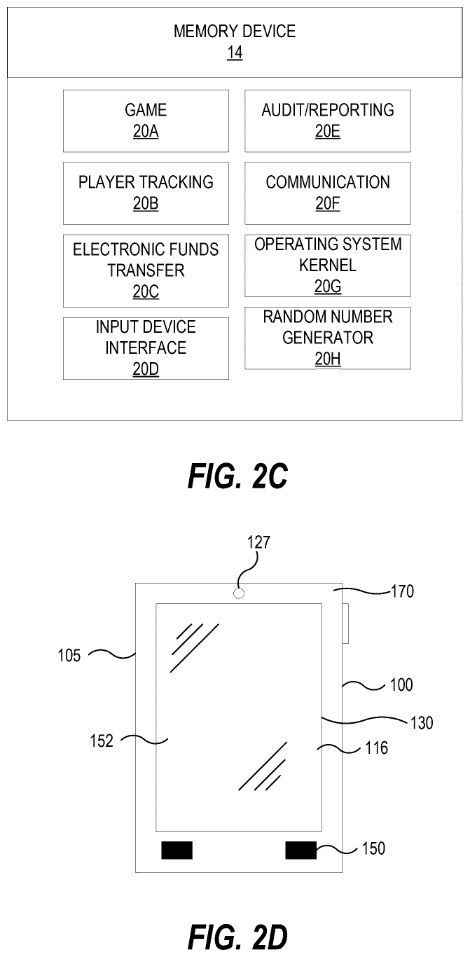

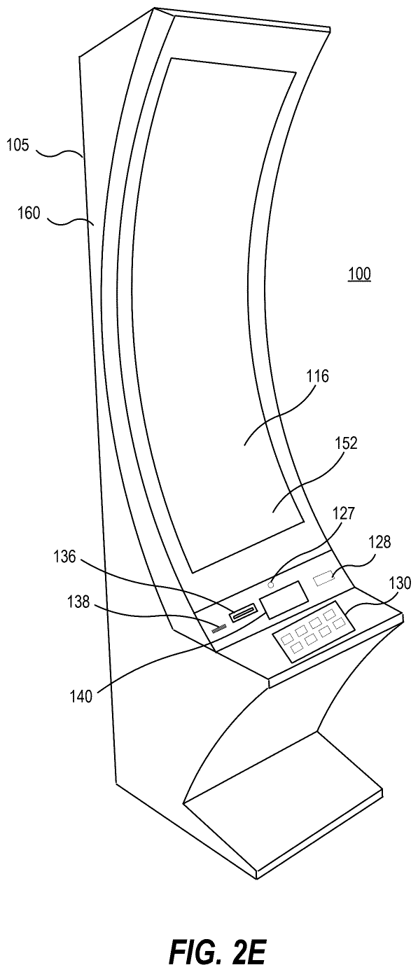

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

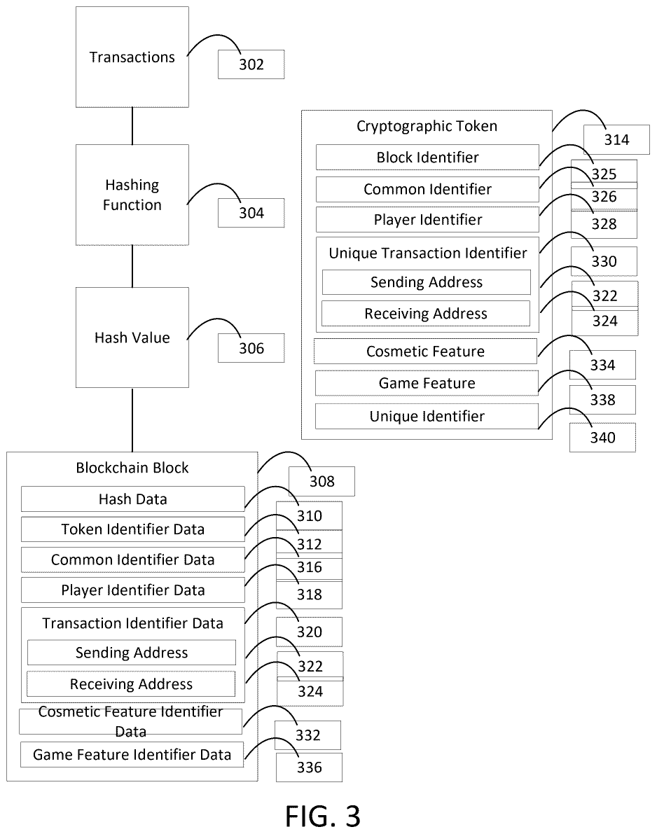

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others. Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include cosmetic feature identifier data 332 associated with a cosmetic feature 334, such as a stored graphical image and/or a graphical modification of a game element of a wagering game. Each block 308 may further include game feature identifier data 336 associated with a game feature 338 for redeeming a portion of a non-monetary credit amount as a monetary award amount. Each cryptographic token 314 may be a fungible token that is fungible with other cryptographic tokens, and/or may further include a unique identifier 340, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

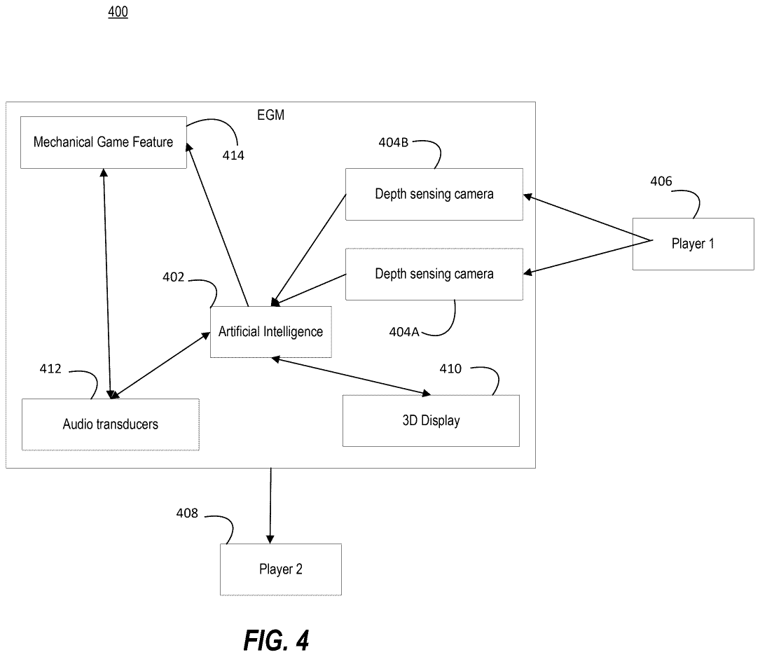

Reference is now made to FIG. 4, which is a schematic block diagram illustrating a system according to some embodiments. A system according to some embodiments may include an EGM 400 including multiple depth sensing cameras 404A, 404B. Some embodiments include a first depth sensing camera 404A and a second depth sensing camera 404B. The depth sensing cameras 404 generate multiple images corresponding to a first player 406 that are used to generate a point cloud that corresponds to a model of the player 406. The system may include multiple audio transducers 412 in a transducer array to perform beam forming using positional information of the first player 406 and to adjust audio content delivered to the first player 406.

The system may include a three-dimensional (3D) display device 410 that provides rendered video frames that are adjusted in real time to adjust a separation of each of the multiple rendered video screens to generate a 3D image. Some embodiments include a processor circuit that may transmit, to equipment of a second player 408, data corresponding to a game on the EGM and provide a communication link between the first player 406 and the second player 408.

Some embodiments provide that the processor circuit includes an artificial intelligence (AI) 402 to receive AI data in a real time video stream that is captured through the depth sensing cameras 404. In some embodiments, the processor circuit may train the AI 402 to distinguish player hands and/portions thereof in a camera view.

In some embodiments, a mechanical game feature 414 that is viewable by the depth sensing cameras 404 is provided. Some embodiments provide that the processor circuit is further caused to transmit video and depth information to a second EGM that uses the mechanical game feature 414. In some embodiments, the processor circuit is caused to remotely control the mechanical game feature 414 using data from the depth sensing cameras 404. In some embodiments, the processor circuit is caused to receive wager data from multiple EGMs, initiate the mechanical game feature 414, and determine an outcome based on a result of the mechanical game feature 414. In some embodiments, the mechanical game feature 414 includes a card deck shuffler. In some embodiments, the 3D display device 410 displays a dealer that causes the card deck shuffler to serve a card to the player based on the images provided by the depth sensing cameras 404.

In some embodiments, the processor circuit is caused to monitor a participating mechanical game feature 414 using the depth sensing cameras 404. Some embodiments provide that the processor circuit is further caused to trigger an action on the mechanical game feature 414 based on gesture data generated by the depth sensing cameras 404.

In some embodiments, the depth sensing cameras 404 communicate with multiple EGMs that includes the EGM 400. The multiple EGMs may be associated with ones of multiple different players that includes the player 406. In some embodiments, the 3D display devices 410 of the EGMs may display a single scene and environment while ones of the players 406, 408 operate concurrently in parallel with each other.

In some embodiments, the depth sensing cameras 404 communicate with the EGM 400 associated with the first player 406 and a second EGM associated with the second player 408. In some embodiments, the 3D display device 410 displays a first virtual hand that is associated with the first player 406 and a second virtual hand that is associated with the second player 408. Some embodiments provide that a collaborative touch interaction between the first virtual hand and the second virtual hand is triggered to cause an action in the game to occur.

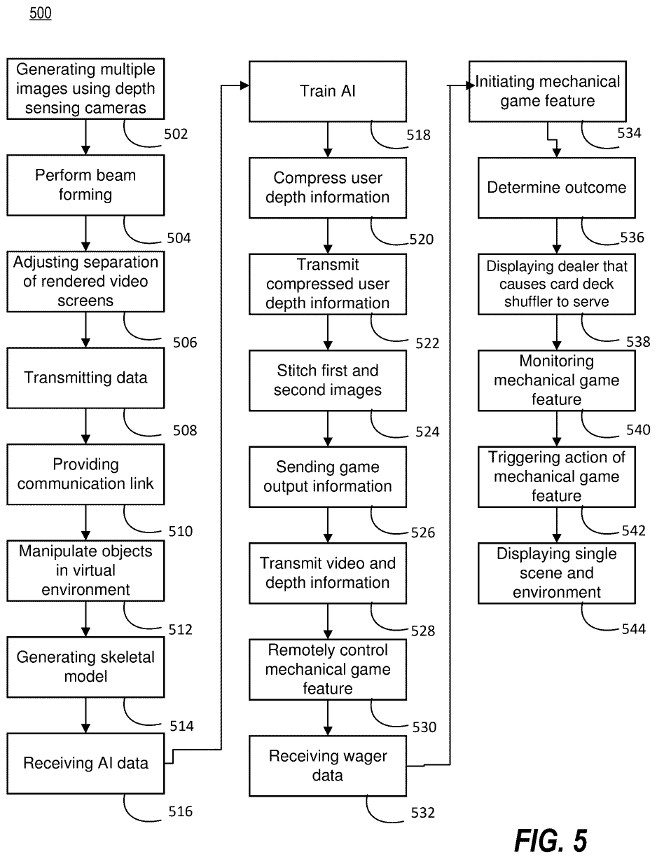

Reference is now made to FIG. 5, which is a flowchart illustrating operations of systems/methods for facilitating embodiments described herein. Some embodiments include a system 500 that includes an electronic gaming machine (EGM) that includes multiple depth sensing cameras that generate (block 502) multiple images corresponding to a player that are used to generate a point cloud that corresponds to a model of the player. Multiple audio transducers may be provided in a transducer array to perform (block 504) beam forming using positional information of the player. The audio content may be adjusted and delivered to the player.

In some embodiments, a three-dimensional (3D) display device including multiple rendered video frames that are adjusted in real time may adjust (block 506) a separation of each of multiple rendered video screens to generate a 3D image.

Some embodiments include a processor circuit and a memory coupled to the processor circuit. The memory may include machine-readable instructions that, when executed by the processor circuit, cause the processor circuit to perform operations including transmitting (block 508), to equipment of another player, data corresponding to a game on the EGM. Operations include providing (block 510) a communication link between the player of the EGM and the other player.

In some embodiments, the multiple depth sensing cameras include an infrared sensor. Some embodiments provide that the depth sensing cameras include a color sensor.

In some embodiments, the depth sensing cameras may include gesture tracking of hands and fingers to manipulate (block 512) objects in a virtual environment in real time.

In some embodiments, the processor circuit may use the point cloud to generate (block 514) a skeletal model of the player from the images. In some embodiments, the skeletal model is movable to match movement of the player.

In some embodiments, the processor circuit that includes an artificial intelligence (AI) to receive (block 516) AI data in a real time video stream that is captured through one of the depth sensing cameras.

Some embodiments include training (block 518) the AI to distinguish multiple player hands in a camera view.

Some embodiments include compressing (block 520) user depth information and color reproduction of the model of the player and transmitting (block 522) compressed user depth information and color reproduction data to another player EGM.

Some embodiments include multiple images including a first image and a second image. In some embodiments, the processor circuit is operable to stitch (block 524) the first image and the second image into a single combined image.

In some embodiments, in response to the player playing a game with a second player at a different EGM, operations may include sending (block 526), by the player and to the second player, game outcome information corresponding to the game. In some embodiments, game state information is viewable to the player and the second player at the same time.

Some embodiments include a mechanical game feature that is viewable by the depth sensing cameras. In some embodiments, the processor circuit transmits (block 528) video and depth information to a second EGM that uses the mechanical game feature.

In some embodiments, the processor circuit may remotely control (block 530) the mechanical game feature using data from the depth sensing cameras.

Operations may include receiving (block 532) wager data from multiple EGMs, initiating (block 534) the mechanical game feature and determining (block 536) an outcome based on a result of the mechanical game feature. In some embodiments, the mechanical game feature includes a card deck shuffler. Some embodiments provide that the 3D display device displays (block 538) a dealer that causes the card deck shuffler to serve a card to the player based on the images provided by the depth sensing cameras.

In some embodiments, the processor circuit further monitors (block 540) a participating mechanical game feature using the depth sensing cameras. In some embodiments, the processor circuit triggers (block 542) an action on the mechanical game feature based on gesture data generated by the depth sensing cameras.

In some embodiments, the depth sensing cameras communicate with multiple EGMs that includes the player's EGM. In some embodiments, the multiple EGMs are associated with ones of multiple players that includes the player. Some embodiments provide that the 3D display devices of the multiple EGMs may display (block 544) a single scene and environment while ones of the multiple players operate concurrently in parallel with each other.

In some embodiments, the multiple depth sensing cameras communicate with the EGM that is associated with the player and a second EGM associated with a second player. The 3D display device may display a first virtual hand that is associated with the player and a second virtual hand that is associated with the second player. A collaborative touch interaction between the first virtual hand and the second virtual hand may be triggered to cause an action in the game to occur.

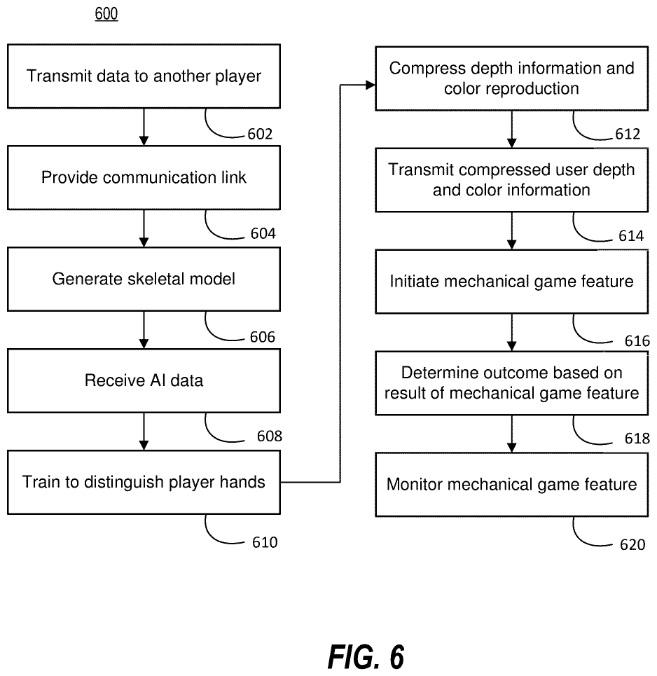

Reference is now made to FIG. 6, which is a flowchart illustrating operations of systems/methods for facilitating embodiments described herein. A system 600 in accordance with FIG. 6 may include a processor circuit and a memory coupled to the processor circuit. The memory includes machine-readable instructions that, when executed by the processor circuit, cause the processor circuit to perform operations including transmitting (block 602), to equipment of another player, data corresponding to a game on an electronic gaming machine (EGM) and providing (block 604) a communication link between the player of the EGM and another player. Operations may include generating (block 606) a skeletal model of the player from multiple images. The skeletal model is movable to match movement of the player. Some embodiments include receiving (block 608), via an artificial intelligence (AI), AI data in a real time video stream that is captured through one of multiple depth sensing cameras.

Some embodiments include training (block 610) to distinguish multiple player hands in a camera view. Embodiments include compressing (block 612) user depth information and color reproduction of the model of the player. Some embodiments include transmitting (block 614) compressed user depth information and color reproduction data to another player EGM. A mechanical game feature may be initiated (block 616) and an outcome may be determined (block 618) based on a result of the mechanical game feature. Operations include monitor (block 620) a participating mechanical game feature using the depth sensing cameras.

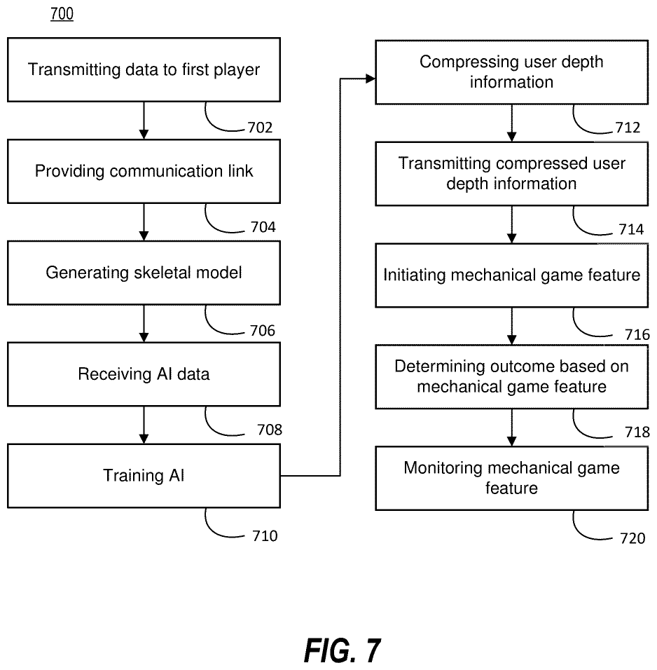

Reference is now made to FIG. 7, which is a flowchart illustrating operations of systems/methods for facilitating embodiments described herein. Such methods may include transmitting (block 702), to equipment of a first player, data corresponding to a game on a EGM and providing (block 704) a communication link between the first player and a second player via respective EGMs. Embodiments include generating (block 706) a skeletal model of the first player from multiple images. In some embodiments, the skeletal model is movable to match movement of the first player. Operations include receiving (block 708), via an artificial intelligence (AI), AI data in a real time video stream that is captured through one of the depth sensing cameras. Embodiments include training (block 710) the AI to distinguish multiple player hands in a camera view.

Some embodiments include compressing (block 712) user depth information and color reproduction of the model associated with the first player and transmitting (block 714) compressed user depth information and color reproduction data to the second player EGM.

Some embodiments include initiating (block 716) a mechanical game feature, determining (block 718) an outcome based on a result of the mechanical game feature, and monitoring (block 720) a participating mechanical game feature using the multiple depth sensing cameras.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
an electronic gaming machine (EGM) comprising:
a plurality of depth sensing cameras that generate a plurality of images corresponding to a player that are used to generate a point cloud that corresponds to a model of the player;
a plurality of audio transducers in a transducer array to perform beam forming using positional information of the player and to adjust audio content delivered to the player;
a three-dimensional (3D) display device comprising a plurality of rendered video frames that are adjusted in real time to adjust a separation of each of a plurality of rendered video screens to generate a 3D image;
a processor circuit; and
a memory coupled to the processor circuit, the memory comprising machine-readable instructions that, when executed by the processor circuit, cause the processor circuit to:
transmit, to equipment of another player, data corresponding to a game on the EGM; and
provide a communication link between the player of the EGM and the another player.

2. The system of claim 1, wherein the plurality of depth sensing cameras comprises an infrared sensor.

3. The system of claim 1, wherein the plurality of depth sensing cameras comprises a color sensor.

4. The system of claim 1, wherein the plurality of depth sensing cameras comprises gesture tracking of hands and fingers to manipulate objects in a virtual environment in real time.

5. The system of claim 1, wherein the machine-readable instructions further cause the processor circuit to use the point cloud to generate a skeletal model of the player from the plurality of images, wherein the skeletal model is movable to match movement of the player.

6. The system of claim 1, wherein the machine-readable instructions further cause the processor circuit that comprises an artificial intelligence (AI) to receive AI data in a real time video stream that is captured through one of the plurality of depth sensing cameras.

7. The system of claim 6, wherein the machine-readable instructions further cause the processor circuit to train the AI to distinguish a plurality of player hands in a camera view.

8. The system of claim 1, wherein the machine-readable instructions further cause the processor circuit to: compress user depth information and color reproduction of the model of the player; and transmit compressed user depth information and color reproduction data to another player EGM.

9. The system of claim 1, wherein the plurality of images comprises a first image and a second image, and
wherein the machine-readable instructions further cause the processor circuit to stitch the first image and the second image into a single combined image.

10. The system of claim 1, wherein, responsive to the player playing a game with a second player at a different EGM, sending, by the player and to the second player, game outcome information corresponding to the game, and wherein game state information is viewable to the player and the second player at a same time.

11. The system of claim 1, further comprising a mechanical game feature that is viewable by the plurality of depth sensing cameras,
wherein the processor circuit is further caused to transmit video and depth information to a second EGM that uses the mechanical game feature.

12. The system of claim 11, wherein the processor circuit is further caused to remotely control the mechanical game feature using data from the plurality of depth sensing cameras.

13. The system of claim 11, wherein the processor circuit is further caused to:
receive wager data from a plurality of EGMs;
initiate the mechanical game feature; and
determine an outcome based on a result of the mechanical game feature.

14. The system of claim 11, wherein the mechanical game feature comprises a card deck shuffler, and
wherein the 3D display device displays a dealer that causes the card deck shuffler to serve a card to the player based on the plurality of images provided by the plurality of depth sensing cameras.

15. The system of claim 1, wherein the processor circuit is further caused to monitor a participating mechanical game feature using the plurality of depth sensing cameras.

16. The system of claim 15, wherein the processor circuit is further caused to trigger an action on the mechanical game feature based on gesture data generated by the plurality of depth sensing cameras.

17. The system of claim 1,
wherein the plurality of depth sensing cameras communicate with a plurality of EGMs that includes the EGM,
wherein the plurality EGMs are associated with ones of a plurality of players that includes the player,
wherein the 3D display devices of the plurality of EGMs display a single scene and environment while ones of the plurality of players operate concurrently in parallel with each other.

18. The system of claim 1,
wherein the plurality of depth sensing cameras communicate with the EGM associated with the player and a second EGM associated with a second player,
wherein the 3D display device displays a first virtual hand that is associated with the player and a second virtual hand that is associated with the second player, and
wherein a collaborative touch interaction between the first virtual hand and the second virtual hand is triggered to cause an action in the game to occur.

19. A system comprising:
a processor circuit; and
a memory coupled to the processor circuit, the memory comprising machine-readable instructions that, when executed by the processor circuit, cause the processor circuit to:
transmit, to equipment of another player, data corresponding to a game on an electronic gaming machine (EGM);
provide a communication link between the player of the EGM and another player;
generate a skeletal model of the player from a plurality of images, wherein the skeletal model is movable to match movement of the player;
receive, via an artificial intelligence (AI), AI data in a real time video stream that is captured through one of a plurality of depth sensing cameras;
train to distinguish a plurality of player hands in a camera view;
compress user depth information and color reproduction of the model of the player;
transmit compressed user depth information and color reproduction data to another player EGM;
initiate a mechanical game feature;
determine an outcome based on a result of the mechanical game feature; and
monitor a participating mechanical game feature using the plurality of depth sensing cameras.

20. A method comprising:
transmitting, to equipment of a first player, data corresponding to a game on a EGM;
providing a communication link between the first player and a second player via respective EGMs;
generating a skeletal model of the first player from a plurality of images, wherein the skeletal model is movable to match movement of the first player;
receiving, via an artificial intelligence (AI), AI data in a real time video stream that is captured through one of a plurality of depth sensing cameras;
training the AI to distinguish a plurality of player hands in a camera view;
compressing user depth information and color reproduction of the model associated with the first player;
transmitting compressed user depth information and color reproduction data to the second player EGM;
initiating a mechanical game feature;
determining an outcome based on a result of the mechanical game feature; and
monitoring a participating mechanical game feature using the plurality of depth sensing cameras.
